(19) United States
(12) Patent Application Publication
(10) Pub. No.: US 2007/0140063 A1
(43) Pub. Date: Jun. 21, 2007

(54) Single dynamic source controlled two groups of hands in clockwise/anticlockwise rotating structure

(76) Inventor: Tieh-Cheng Shu, Hemel Township (TW)

Correspondence Address: TROXELL LAW OFFICE PLLC, SUITE 1404, 5205 LEESBURG PIKE, FALLS CHURCH, VA, 22041, US

(21) Appl. No.: 11/599,618

(22) Filed: Nov. 15, 2006

(30) Foreign Application Priority Data
Dec. 21, 2005 (TW) 094222274

(51) Int. Cl. G04C 11/00

(52) U.S. Cl. 368/46

(57) ABSTRACT

A single dynamic source controlled two hands group in clockwise/anticlockwise rotating structure, which sets two groups of numbered face in reverse direction on face of wristwatch, each numbered face has hour, minute and second hand, wherein active shaft of one hands group is driven by active gear, and passive shaft of another hands group is driven by passive gear, diameter, number of teeth and clearance of tooth of passive gear are as same as active gear; one driving gear drives active gear to rotate, and this active gear meshes with two steering gears to drive another hands group to rotate in reverse direction, thus, one hands group rotates clockwise and another hands group rotates anticlockwise. So that, it is interesting to watch time on your wristwatch, moreover, owing to the anticlockwise arrangement of hands group and numbered face, user can directly confirm the left time as required and the wristwatch can display kinds of time according.

### BACKGROUND OF THE INVENTION

1. Field of the Invention

This invention relates to a single dynamic source controlled two groups of hands in clockwise/anticlockwise rotating structure, which controls the active and passive gear of two groups of hands to rotate clockwise and anticlockwise basing on the single dynamic source of driving gear and mesh conduction of two steering gears setting at middle, the hands can be arranged with clockwise and anticlockwise numbered faces, therefore, such structure can display several kinds of time.

2. Description of the Prior Art

According to the current invention, wristwatch on sale applies single dynamic source to control rotation of single hands group which directly displays time with help of hands and numbered face matching to model of wristwatch; though this model of wristwatch marks clear graduations and numbers or partial graduations, whatever it is, such structure can only display normal time, thereby, appearance and operating function are simple without significant characteristics. Therefore, the current wristwatch on sale often attracts customers by its colorful design in strap; the colorful metal or leather strap can indeed beautify appearance of wristwatch, however, its function is single (without any added function), namely, only displays time. So, its function is limited.

### SUMMARY OF THE INVENTION

### 1. Problem to Solve

(1) Usual wristwatch pays more attention to design of appearance and strap, however, its operating function still halts at visual effect on normal time, thereby, it only has visual aesthetic feeling without progress in operating function.

(2) A usual multi-functional wristwatch is at most added second hand or depth to resist water, however, such function is not popular special function, so, it is not practical, furthermore, its structure is complicated and expensive, which are the main reason why most customers can not receive it.

(3) If want to know the left time from the current wristwatch, you need to watch the normal time and then make calculation by yourself, however, such method is inconvenient and incorrect, besides, such calculation can be done correctly only o' clock, so, it is easy to make mistake.

### 2. Solutions

(1) The single dynamic source of this invention which controls two groups of hands respectively to rotate in reverse direction makes a double hands-displaying wristwatch structure by use numbered face in reverse direction, so that you can watch two kinds of time at same time.

(2) Basing on the two kinds of time-displaying mode of this invention, it is easy for you to determine the left time between the normal time and the appointed or set time, so that you can make best use of the time.

(3) Owing to the application of two kinds of time-displaying mode, user can select the visual effect according to one's own desire, furthermore, it can also make wristwatch be more colorful and fashionable.

### BRIEF DESCRIPTION OF THE DRAWINGS

FIG. 1 is the exploded view of structure of this invention.

FIG. 2 is the combined operating sketch map of structure of this invention.

FIG. 3 is the driving sketch map of structure of this invention.

FIG. 4 is the turning sketch map of hands group of this invention.

FIG. 5-A is the sketch map of aligned hands of this invention.

FIG. 5-B is another sketch map of aligned hands of this invention.

FIG. 6-A is the sketch map of main and secondary face with hands of this invention.

FIG. 6-B is another sketch map of main and secondary face with hands of this invention.

### DETAILED DESCRIPTION OF THE PREFERRED EMBODIMENTS

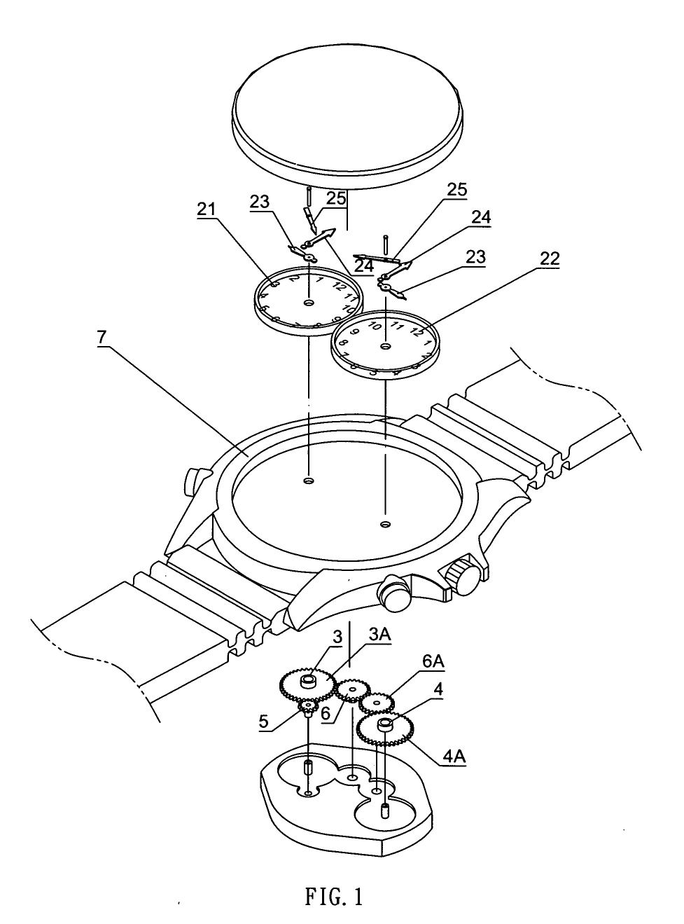

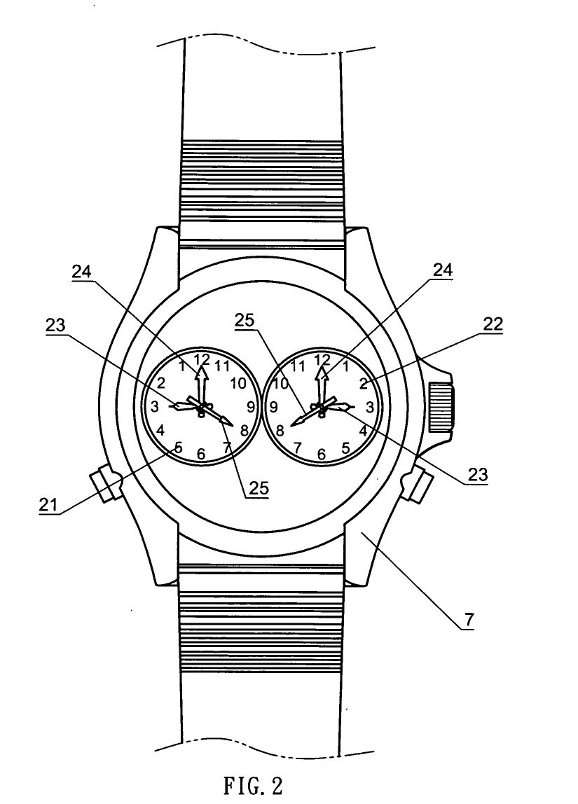

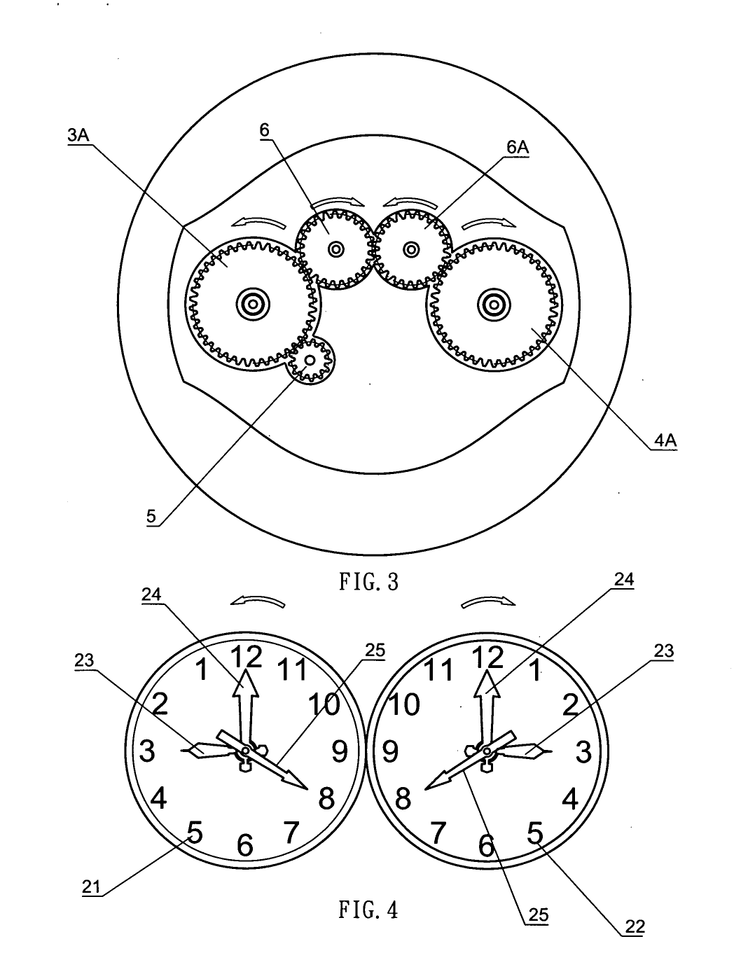

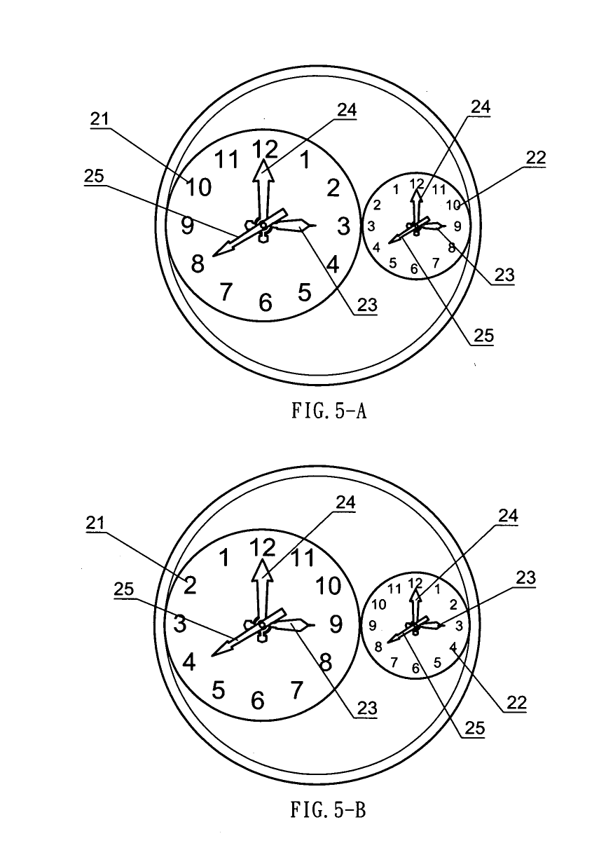

First of all, please refer to FIG. 1, FIG. 2, FIG. 3 and FIG. 4, features of this invention are as follows:

Two groups of numbered face 21 and 22 in reverse direction are set on face of wristwatch 2, each numbered face has hour hand 23, minute hand 24 and second hand 25, wherein active shaft 3 of hands group 26 is driven by active gear 3A, and passive shaft 4 of another hands group 27 is driven by passive gear 4A, diameter, number of teeth and clearance of tooth of passive gear 4A are as same as active gear 3A; driving gear 5 drives active gear 3A to rotate and active gear 3A is meshed by steering gear 6 and 6A, steering gear 6A meshes with passive gear 4A so that another hands group 27 rotates in reverse direction (see FIG. 3 for detail), and hands group 26 rotates clockwise, however, another hands group 27 rotates anticlockwise (see FIG. 4 for detail), thus, two hands groups 26 and 27 can rotate in reverse direction, thus, a special double-hands group displaying wristwatch 7 is made, it will be interesting to watch time. (see FIG. 2 for detail).

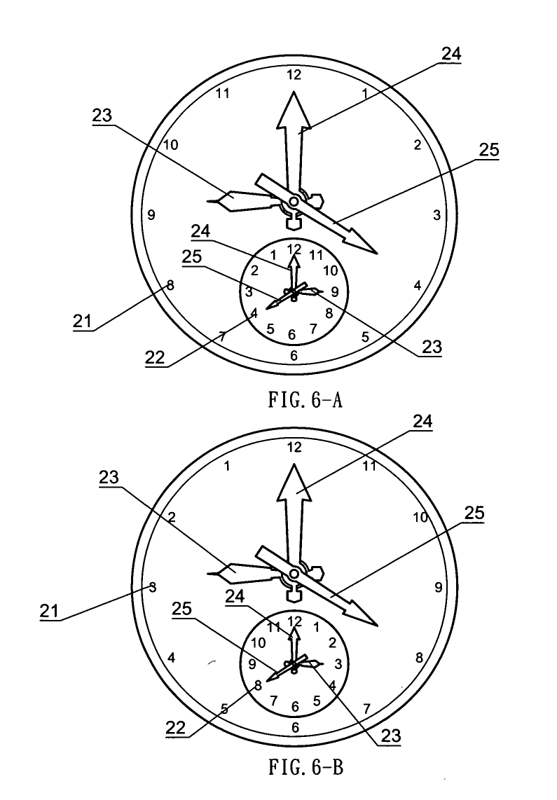

In addition, please refer to FIG. 5-A, FIG. 5-B and FIG. 6A, FIG. 6-B, this invention can align the two groups of numbered face 21 and 22 in reverse direction or arrange them according to their sizes; as left hands group 26A rotates clockwise, numbered face 21 is arranged clockwise, however, right hands group 27A rotates anticlockwise, its numbered face is also arranged anticlockwise (see FIG. 5-A for detail); if left hands group 26A rotates anticlockwise, its numbered face 21 is arranged anticlockwise, however, right hands group 27A rotates clockwise, and its numbered face 22 is also arranged clockwise (as shown in FIG. 5-B); if set the two numbered faces in reverse direction as main face and secondary face, as hands group 26B of main face rotates clockwise, its numbered face 21 is also arranged clockwise, and hands group 27B of secondary face at this time rotates anticlockwise, its numbered face 22 is arranged anticlockwise (refer to FIG. 6-A); however, if hands group of main face 26B rotates anticlockwise, its numbered face 21 is arranged anticlockwise, and hands group of secondary face 27B at this time rotates clockwise, its numbered face 22 is also arranged clockwise (refer to FIG. 6-B), so that it is very interesting to watch time, moreover, owing to the clockwise and anticlockwise rotating numbered faces, wristwatch 7 can display several kinds of time, you can watch the left time and confirm it directly.

What is claimed is:

1. A single dynamic source controlled two groups of hands in clockwise/anticlockwise rotating structure, the features are as follows:
Two groups of numbered face and arranged in reverse direction are set on face of wristwatch, each numbered face has hour, minute and second hand, wherein active shaft of one hands group is driven by active gear and passive shaft of another hands group is driven by passive gear, diameter, number of teeth and clearance of tooth of passive gear are as same as active gear; one driving gear drives active gear to rotate, and this active gear meshes with two steering gears to drive another hands group to rotate in reverse direction, thus, one hands group rotates clockwise and another hands group rotates anticlockwise. So that, it is interesting to watch time on your wristwatch, moreover, owing to the anticlockwise arrangement of hands group and numbered face, user can directly confirm the left time as required and the wristwatch can display kinds of time accordingly.

2. As claimed in claim 1, wherein said two groups of numbered face in reverse direction can be arranged in upper and below or left and right alignment.

3. As claimed in claim 1, wherein said two groups of numbered face in reserve direction can be arranged according to their sizes.

4. As claimed in claim 1, wherein said two groups of numbered face in reserve direction can be set as main and secondary face in practical application.
